(19) United States
(12) Patent Application Publication
(10) Pub. No.: US 2013/0268475 A1
(43) Pub. Date: Oct. 10, 2013

(54) INFORMATION PROCESSING APPARATUS, A METHOD AND A NON-TRANSITORY COMPUTER READABLE MEDIUM THEREOF, AND AN INFORMATION COMMUNICATION TERMINAL, A CONTROL METHOD AND A NON-TRANSITORY COMPUTER READABLE MEDIUM THEREOF

(71) Applicants: Hayato Kobayashi, Kanagawa-ken (JP); Hiromi Wakaki, Tokyo (JP); Tomohiro Yamasaki, Tokyo (JP); Masaru Suzuki, Kanagawa-ken (JP)

(72) Inventors: Hayato Kobayashi, Kanagawa-ken (JP); Hiromi Wakaki, Tokyo (JP); Tomohiro Yamasaki, Tokyo (JP); Masaru Suzuki, Kanagawa-ken (JP)

(73) Assignee: KABUSHIKI KAISHA TOSHIBA, Tokyo (JP)

(21) Appl. No.: 13/710,976

(22) Filed: Dec. 11, 2012

(30) Foreign Application Priority Data
Apr. 10, 2012 (JP) 2012-089750

(51) Int. Cl. G06N 5/02

(52) U.S. Cl. CPC G06N 5/02
USPC 706/46

(57) ABSTRACT

According to one embodiment, a contents storage unit stores a plurality of contents. An additional information storage unit stores a plurality of additional information each differently corresponding to each of the contents. A selection history storage unit stores a history of selection from the contents and the additional information by a user in the past. A first estimation unit estimates a first preference information representing a tendency of the user's preference for the contents, based on the history. A second estimation unit estimates a second preference information representing a tendency of the user's preference for the additional information, based on the history. A selection unit selects a recommended content from the contents, and selects a recommended additional information from the additional information, based on the first preference information and the second preference information.

### CROSS-REFERENCE TO RELATED APPLICATION

This application is based upon and claims the benefit of priority from Japanese Patent Application No. 2012-089750, filed on Apr. 10, 2012; the entire contents of which are incorporated herein by reference.

### FIELD

Embodiments described herein relate generally to an information processing apparatus, a method and a non-transitory computer readable medium thereof, and an information communication terminal, a control method and a non-transitory computer readable medium thereof.

### BACKGROUND

As to a site of an electronic commerce on Internet, some information processing method is well known. In this method, based on a tendency of contents (books, musical pieces, foods, and so on) which a user has purchased in the past, by estimating recommended contents for the user to take an interest, the recommended contents are presented to the user.

However, only by simply the recommended contents to the user, the user does not often take an interest in the recommended contents. Accordingly, in the information processing method of conventional technique, not only recommended contents but also additional information corresponded therewith are often presented to the user.

For example, a review written by another user for the recommended contents is presented to the user. Furthermore, by estimating keywords representing feature of the recommended contents, the keywords are presented to the user. Furthermore, by generating a catch phrase from guide information of the recommended contents, the catch phrase is presented to the user.

However, in these conventional techniques, change of the user's preference by presenting the additional information is not estimated. As a result, contents which the user actually takes an interest cannot be estimated.

### BRIEF DESCRIPTION OF THE DRAWINGS

FIG. 1 is one example of a display showing a usage situation according to one embodiment.

FIG. 2 is a block diagram of an information processing apparatus 1 according to one embodiment.

FIG. 3 is a flow chart of processing of the information processing apparatus 1.

FIGS. 4A and 4B are examples of book information and a book attribute.

FIG. 5 is a flow chart of processing of an additional information acquisition unit 11 in FIG. 2.

FIG. 6 is one example of catch phrase information.

FIG. 7 is a flow chart of processing of an attribute extraction unit 12 in FIG. 2.

FIG. 8 is one example of a semantic dictionary used by the attribute extraction unit 12.

FIG. 9 is one example of a table storing a catch phrase ID and a catch phrase ID.

FIG. 10 is a flow chart of processing of a detection unit 13 in FIG. 2.

FIG. 11 is one example of a selection history.

FIG. 12 is one example of first preference information.

FIG. 13 is a flow chart of processing of a first estimation unit 14 in FIG. 2.

FIG. 14 is one example of second preference information.

FIG. 15 is a flow chart of processing of second preference information.

FIG. 16 is a flow chart of processing of a score calculation unit 16 in FIG. 2.

FIG. 17 is a schematic diagram to explain one example of a method for calculating a recommendation score Z.

FIG. 18 is a block diagram of an information communication terminal 10 according to one embodiment.

FIG. 19 is one example showing a display situation of a display unit 22 in FIG. 18.

### DETAILED DESCRIPTION

According to one embodiment, an information processing apparatus includes a contents storage unit, an additional information storage unit, a selection history storage unit, a first estimation unit, a second estimation unit, and a selection unit. The contents storage unit stores a plurality of contents. The additional information storage unit stores a plurality of additional information each differently corresponding to each of the contents. The selection history storage unit stores a history of selection from the contents and the additional information by a user in the past. The first estimation unit is configured to estimate a first preference information representing a tendency of the user's preference for the contents, based on the history. The second estimation unit is configured to estimate a second preference information representing a tendency of the user's preference for the additional information, based on the history. The selection unit is configured to select a recommended content from the contents, and to select a recommended additional information from the additional information, based on the first preference information and the second preference information.

Various embodiments will be described hereinafter with reference to the accompanying drawings.

### EMBODIMENTS

An information processing apparatus 1 of a first embodiment is suitable for a server connectable with an information communication terminal 10 such as a personal computer (PC) or a smart phone.

As to contents such as books, musical pieces or foods, the information processing apparatus 1 acquires additional information (For example, catch phrase) from a user who utilizes the information processing apparatus 1. In the information processing apparatus 1, from a history of contents browsed (accessed) or purchased by the user (target user of the information communication terminal 10) in the past, the user's preference for contents and additional information is estimated. Based on the user's preference, contents and additional information to be presented to the user are determined. As a result, contents which the user actually takes an interest can be estimated.

In the present embodiment, the case that contents are “books” and additional information is “catch phrase” will be explained.

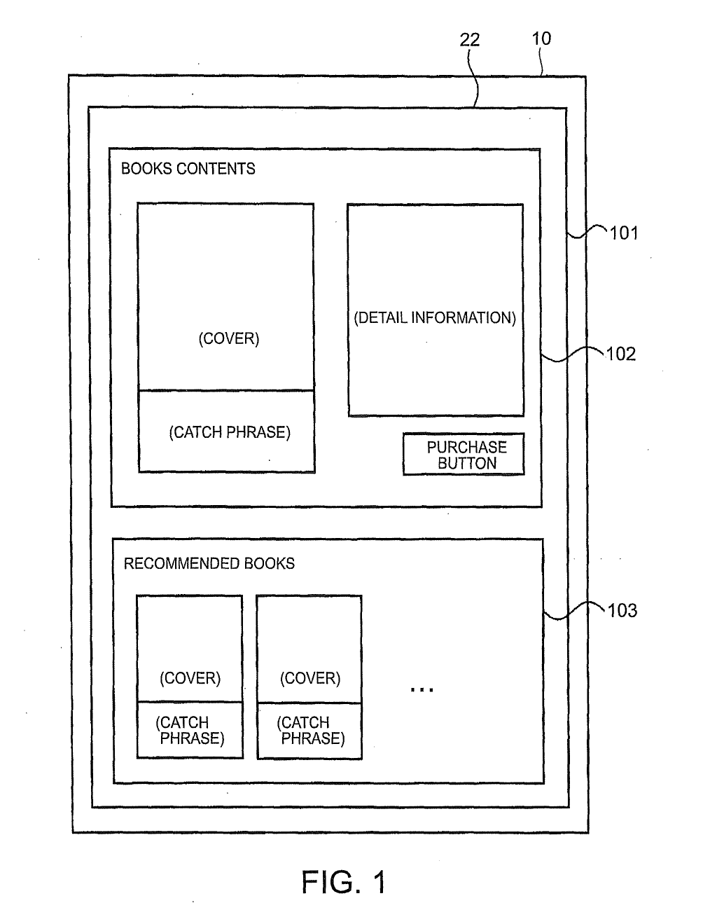

FIG. 1 is one example of a display of usage status according to the present embodiment. In FIG. 1, on a display unit 22 (explained afterwards) of the information communication terminal 10, a page 101 to sell books in electronic commerce site is displayed. In this page 101, two regions 102 and 103 are included.

In a region 102, a cover of a book having a belt (belly band) in which a catch phrase of the book is described, detail information of the book, and a purchase button to purchase the book, are displayed. In a region 103, a recommended book to recommend to a user is displayed with a belt in which a catch phrase thereof is described. The information processing apparatus 1 of the present embodiment determines the recommended book and a catch phrase thereof to be displayed on the region 103.

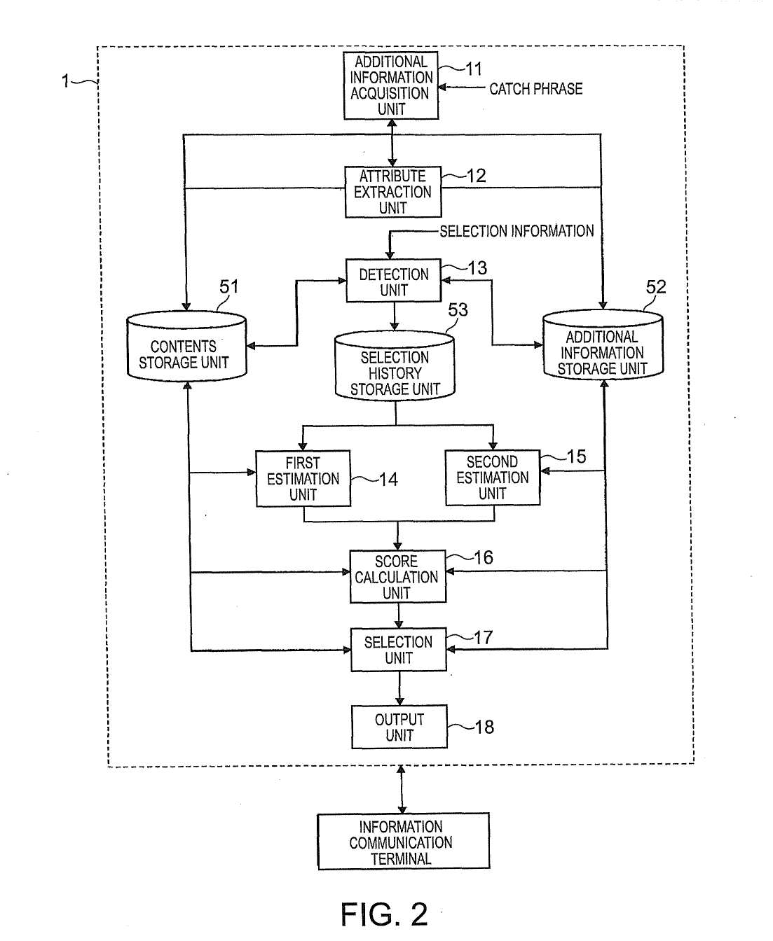

FIG. 2 is a block diagram of the information processing apparatus 1. The information processing apparatus 1 includes a contents storage unit 51, an additional information storage unit 52, a selection history storage unit 53, an additional information acquisition unit 11, an attribute extraction unit 12, a detection unit 13, a first estimation unit 14, a second estimation unit 15, a score calculation unit 16, a selection unit 17, and an output unit 18.

The contents storage unit 15 correspondingly stores detail information of a book and a book attribute thereof as book information. The book attribute is represented by combination of keywords each representing a feature of the book. Moreover, the combination of keywords may be represented by numerical values according to predetermined rule.

As to book information stored in the contents storage unit 51, the additional information acquisition unit 11 acquires a catch phrase inputted by a plurality of users. Here, the user may be a person who utilizes the information processing apparatus 1 or a salesman of the book.

The attribute extraction unit 12 semantically analyzes the catch phrase, and extracts an attribute of the catch phrase (catch phrase attribute). The catch phrase attribute is represented by combination of keywords each representing a feature of the catch phrase. Moreover, the combination of keywords may be represented by numerical values according to predetermined rule.

The attribute extraction unit 12 correspondingly writes the catch phrase and the catch phrase attribute into the additional information storage unit 52.

The detection unit 13 detects whether a target user selects a book or a catch phrase displayed on a page 101 for book sales. For example, the detection unit 13 detects whether the user clicks a book, a catch phrase, or a purchase button on the page 101. The detection unit 13 writes the book and the catch phrase selected by the user until the present time, as a history of the user's selection, into the selection history storage unit 53. Hereinafter, the history of the user's selection is called a selection history.

By using the selection history, the first estimation unit 14 estimates first preference information representing tendency of the user's preference for books. The detail processing will be explained afterwards.

By using the selection history, the second estimation unit 14 estimates second preference information representing tendency of the user's preference for books. The detail processing will be explained afterwards.

Based on the first preference information and the second preference information, as to a pair (combination) of each book information (stored in the contents storage unit 51) and each catch phrase (stored in the additional information storage unit 52), the score calculation unit 16 calculates a recommendation score to evaluate what extent the user takes an interest.

From all pairs (all combinations) of each book information and each catch phrase, the selection unit 17 selects at least one pair of which the recommendation score is higher. The selection unit 17 selects book information included in the selected pair from the contents storage unit 51. The selection unit 17 extracts a catch phrase included in the selected pair from the additional information storage unit 52.

The output unit 18 outputs the book information and the catch phrase to the information communication terminal 10. The book information outputted via the information communication terminal 10 is recommended book information, and the catch phrase outputted via the information communication terminal 10 is recommended catch phrase.

The additional information acquisition unit 11, the attribute extraction unit 12, the detection unit 13, the first estimation unit 14, the second estimation unit 15, the score calculation unit 16, the selection unit 17 and the output unit 18, may be realized by a central processing unit (CPU) and a memory used thereby. The contents storage unit 51, the additional information storage unit 52 and the selection history storage unit 53, may be realized by the memory or an auxiliary storage device.

Thus far, component of the information processing apparatus 1 is already explained.

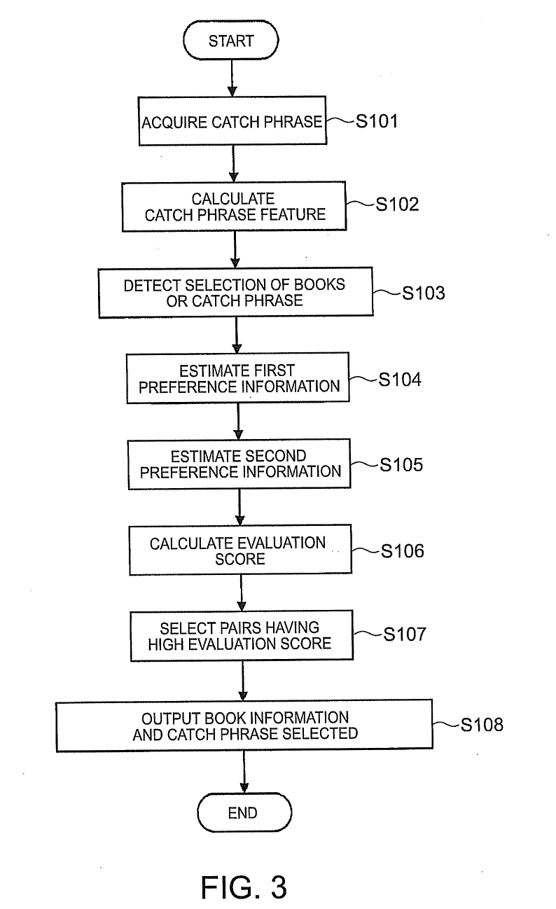

FIG. 3 is a flow chart of processing of the information processing apparatus 1. As to book information stored in the contents storage unit 51, the additional information acquisition unit 11 acquires a catch phrase added by a user who utilizes the information processing apparatus 1 (S101).

The attribute extraction unit 12 semantically analyzes the catch phrase, and extracts a catch phrase attribute (S103). The attribute extraction unit 12 correspondingly writes the catch phrase and the catch phrase attribute into the additional information storage unit 52.

The detection unit 13 detects whether the user selects a book or a catch phrase displayed on a page 101 for book sales (S103). The detection unit 13 writes the book and the catch phrase selected by the user until the present time, as a selection history into the selection history storage unit 53.

By using the user's selection history, the first estimation unit 14 estimates first preference information (S104). By using the user's selection history, the second estimation unit 14 estimates second preference information (S105).

Based on the first preference information and the second preference information, as to each pair (each combination) of each book information (stored in the contents storage unit 51) and each catch phrase (stored in the additional information storage unit 52), the score calculation unit 16 calculates a recommendation score (S106).

From pairs of each book information and each catch phrase, the selection unit 17 selects at least one pair of which the recommendation score is higher (S107). The selection unit 17 selects book information included in the selected pair from the contents storage unit 51. The selection unit 17 extracts a catch phrase included in the selected pair from the additional information storage unit 52. In the present embodiment, one pair of which the recommendation score is the highest is selected. Accordingly, one book information and one catch phrase thereof are extracted.

The output unit 18 outputs the book information and the catch phrase (each selected) to the information communication terminal 10 (S108).

Thus far, processing of the information processing apparatus 1 is already explained.

Hereinafter, detail processing of the information processing apparatus 1 is explained.

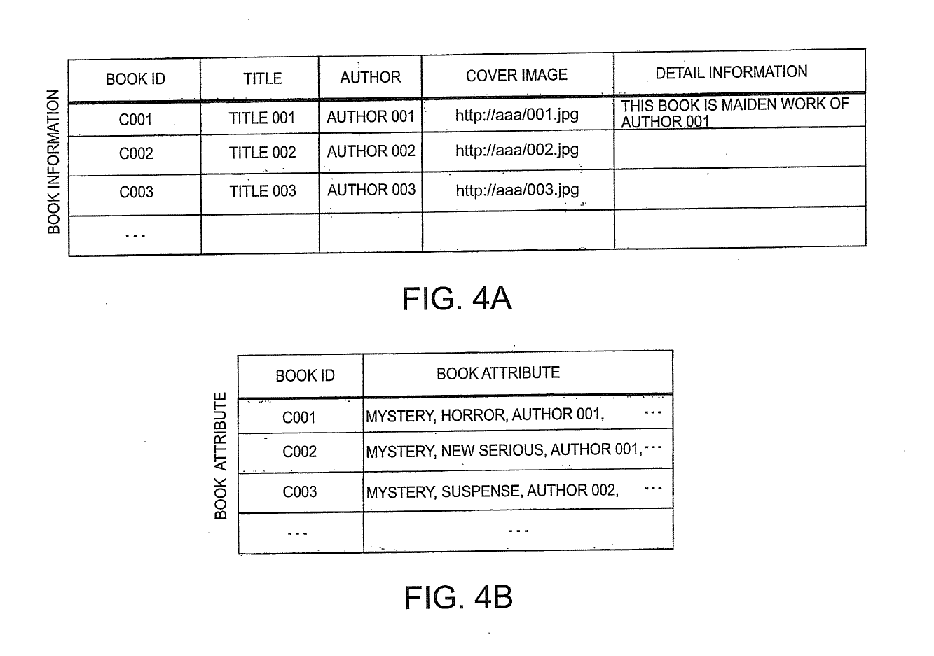

The contents storage unit 51 correspondingly stores book information and the book attribute thereof. FIGS. 4A and 4B are examples of the book information and the book attribute. As shown in FIG. 4A, for example, the book information includes a book ID, a title, an author, a cover image, and detail information. The book information is stored in the contents storage unit 51.

The book attribute is previously set based on detail information of each book, and stored in correspondence with the book ID into the contents storage unit 51. Moreover, the book attribute may be stored into another storage unit (not shown in Fig.) by managing with an attribute ID.

In FIG. 4B, a book “C001” includes book attributes “mystery”, “horror” and “author 001”, but does not include book attributes “suspense” and “author 002”. In this example, information representing whether each book attribute exists is only used. However, each book attribute may be stored by weighting therewith.

The additional information acquisition unit 11 acquires a catch phrase of a book stored in the contents storage unit 51. In the present embodiment, the catch phrase is acquired by an input from a user who utilizes the information processing apparatus 1. For example, the user is imagined as a person having a user ID to utilize the information processing apparatus 1. However, the user may be limited to a specific user such as a salesman of book, an artiste or a copy writer.

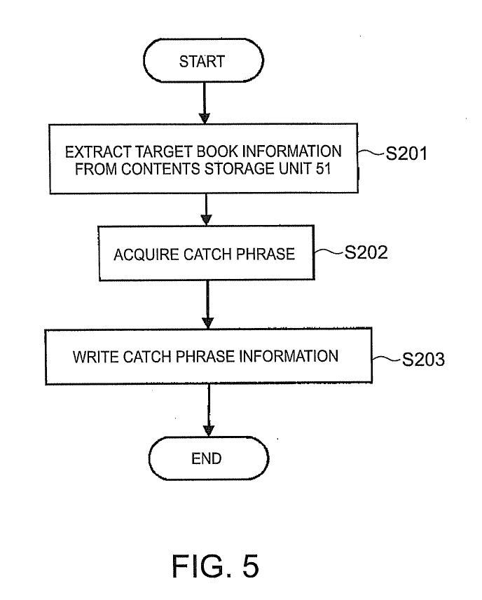

FIG. 5 is a flow chart of processing of the additional information acquisition unit 11. Here, a user ID of the user who inputs the catch phrase is decidable by log-in operation.

The additional information acquisition unit 11 extracts target book information as a target to assign a catch phrase from the contents storage unit 51 (S201).

For example, in FIG. 4A, the additional information acquisition unit 11 extracts book information (target book information) of a book having book ID “C001” from the contents storage unit 51. In this case, in book information of the book ID “C001”, “title 001” as the title, “author 001” as the author, “http://aaa/001.jpg” as the cover image, and “This book is maiden work of author 001” as the detail information, are corresponded.

Moreover, the target book information may be actively selected by the user or selected by the additional information acquisition unit 11 based on book information of books purchased by the user in the past. In order for the user (who will assign a catch phrase) to confirm, the additional information acquisition unit 11 displays the catch phrase (extracted) via the information communication terminal utilized by the user. For example, the additional information acquisition unit 11 may display the book information (extracted) with an input form to input a catch phrase and a contribution button to contribute the catch phrase via the information communication terminal.

After the user has written a catch phrase into the input form and pushed the contribution button, the additional information acquisition unit 11 acquires the catch phrase written into the input form (S202). The additional information acquisition unit 11 writes catch phrase information correspondingly including the catch phrase, a catch phrase ID, a book ID and a user ID, into the additional information storage unit 52 (S203).

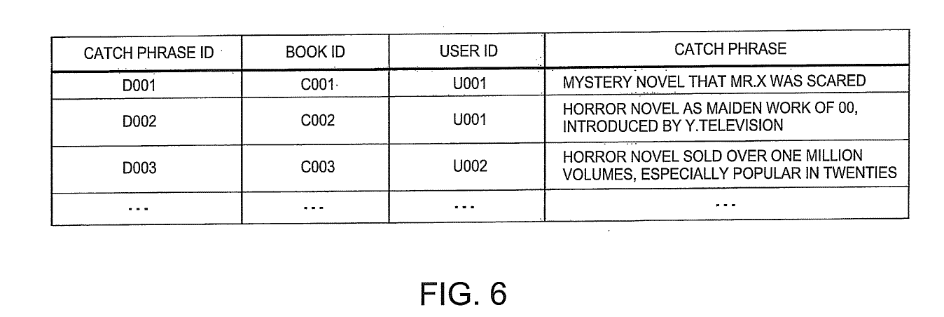

FIG. 6 is one example of the catch phrase information. As shown in FIG. 6, for example, the catch phrase information correspondingly includes a catch phrase ID, a book ID, a user ID and a catch phrase.

The attribute extraction unit 12 semantically analyzes the catch phrase, and extracts a catch phrase attribute of a target book to which the catch phrase is assigned. Extraction of the catch phrase attribute may be executed whenever the user inputs the catch phrase.

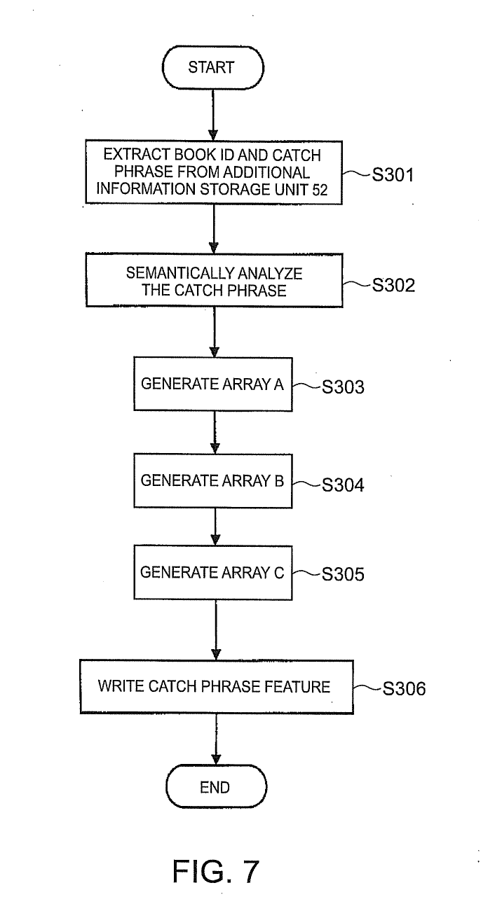

FIG. 7 is a flow chart of processing of the attribute extraction unit 12. The attribute extraction unit 12 extracts a book ID and a catch phrase corresponding to the catch phrase ID (as an extraction target) from the additional information storage unit 52 (S301). For example, as shown in FIG. 6, as to the catch phrase ID “D001”, the attribute extraction unit 12 extracts “C001” as the book ID and “mystery novel that Mr.X was scared” as the catch phrase.

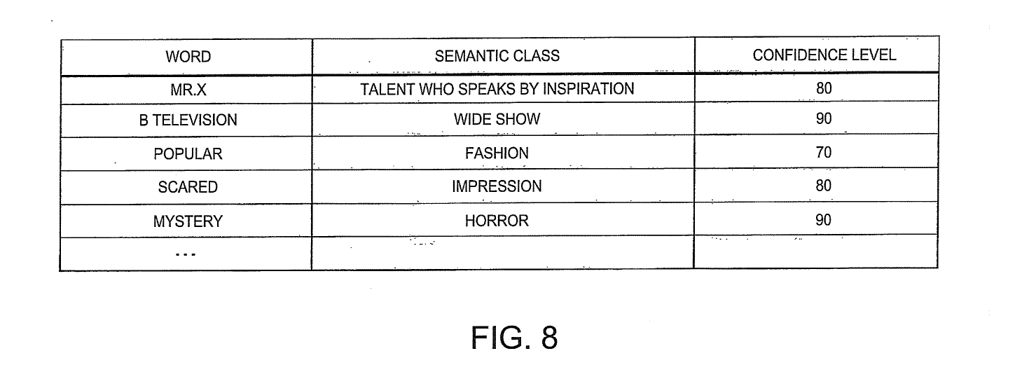

As to the catch phrase extracted, the attribute extraction unit 12 semantically analyzes by using a semantic dictionary shown in FIG. 8 (S302). Briefly, the attribute extraction unit 12 decides whether each word registered in the semantic dictionary is included in the catch phrase, and generates an array A of semantic class corresponding to words included in the catch phrase.

For example, as to the catch phrase “mystery novel that Mr.X was scared”, the attribute extraction unit 12 respectively extracts a semantic class “talent who speaks by inspiration” for “Mr.X”, a semantic class “impression” for “scared”, and a semantic class “horror” for “mystery”, from the semantic dictionary.

In this case, from these semantic classes, the attribute extraction unit 12 generates an array A “talent who speaks by inspiration, impression, horror”. Moreover, as to a word having a plurality of meaning, all semantic classes may be extracted, a semantic class having the largest confidence level (shown in FIG. 8) may be extracted, or a semantic class having the same meaning as other words positioned before or after the word may be selected.

The attribute extraction unit 12 extracts a book attribute corresponding to the book ID (extracted from the additional information storage unit 52) from the contents storage unit 51, and generates an array B of the book attribute (S304). For example, from the book attribute corresponding to the book ID “C001” shown in FIG. 4B, the attribute extraction unit 12 generates an array B “mystery, horror, author 001”.

The attribute extraction unit 12 subtracts elements of the array B from elements of the array A, and generates an array C (S305). In above-mentioned example, the array B “mystery, horror, author 001” is subtracted from the array A “talent who speaks by inspiration, impression, horror”, and the array C “talent who speaks by inspiration, impression” is generated. However, for example, as to a catch phrase “comedy novel that the horror novelist ◯◯ extols” assigned to a book not having element “horror”, the book attribute thereof does not include “horror”. Accordingly, as the catch phrase attribute, “horror” is extracted (not deleted).

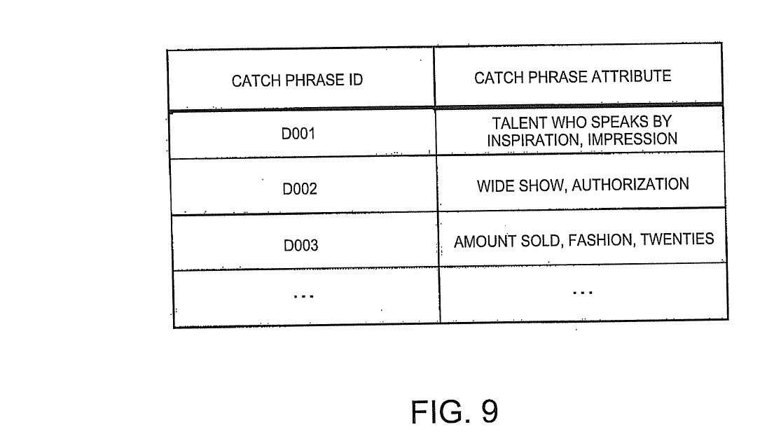

Moreover, an element of the catch phrase attribute is not limited to the semantic class. The element may be a morpheme or a part of speech (as morphological analysis result of the catch phrase), a length of the catch phrase, or created by an author of the catch phrase. For example, as shown in FIG. 9, the attribute extraction unit 12 correspondingly writes the catch phrase attribute (based on the array C) and the catch phrase ID thereof into the additional information storage unit 52 (S306). Briefly, the additional information storage unit 52 correspondingly stores the catch phrase ID of the catch phrase (acquired by the additional information acquisition unit 11) and the catch phrase attribute (extracted by the attribute extraction unit 12).

While the user is utilizing an electronic commerce site by the information processing apparatus 1, as to a book having a catch phrase displayed on a display unit of the information communication terminal 10, the detection unit 13 detects selection information representing the user has clicked, and writes the selection information as a history (selection history) into the selection history storage unit 53.

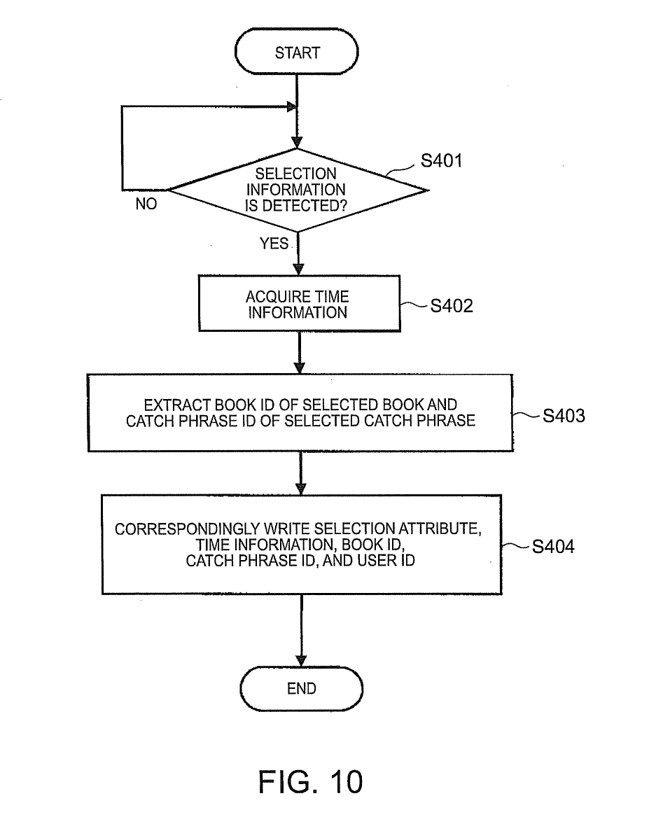

FIG. 10 is a flow chart of processing of the detection unit 13. Moreover, the user ID is already known.

The detection unit 13 decides whether selection information is detected (S401). When the selection information is not detected (No at S401), the detection unit 13 waits until the selection information is detected.

When the selection information is detected (Yes at S401), the detection unit 13 acquires information (time information) related to time at which the selection information is detected (S402). For example, by using a clock (not shown in Fig.) to measure time information, the detection unit may acquire the time information.

The detection unit 13 extracts a book ID of the selected book from the contents storage unit 51, and extracts a catch phrase ID of the selected catch phrase from the additional information storage unit 52 (S403).

The detection unit 13 correspondingly writes a selection attribute representing a type (For example, a click for purchase or a click for browse (access)) of the selection information, the time information, a book ID, a catch phrase ID and a user ID, into the selection history storage unit 53 (S404).

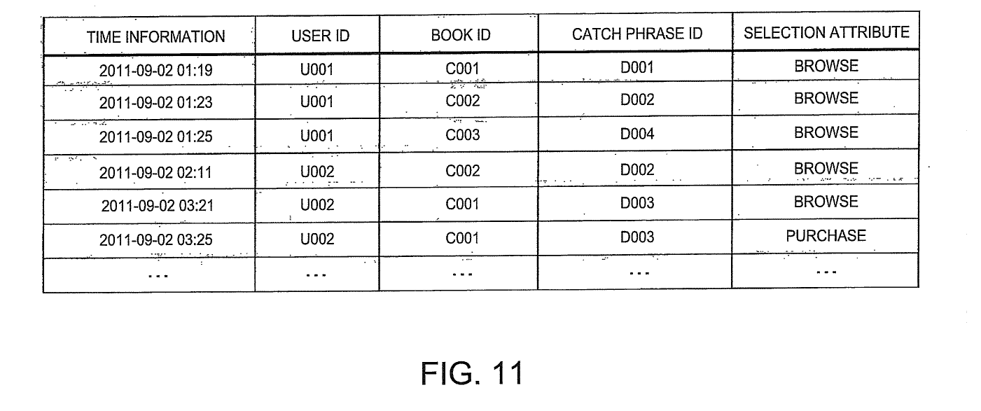

FIG. 11 is one example of the selection history stored in the selection history storage unit 53. As shown in FIG. 11, the selection history includes time information, a user ID, a book ID, a catch phrase ID and a selection attribute. Moreover, this selection history is only one example. The selection history may include a page browsed by the user or a browse time thereof. In this case, the detection unit 13 detects information of the pages browsed and the browse time.

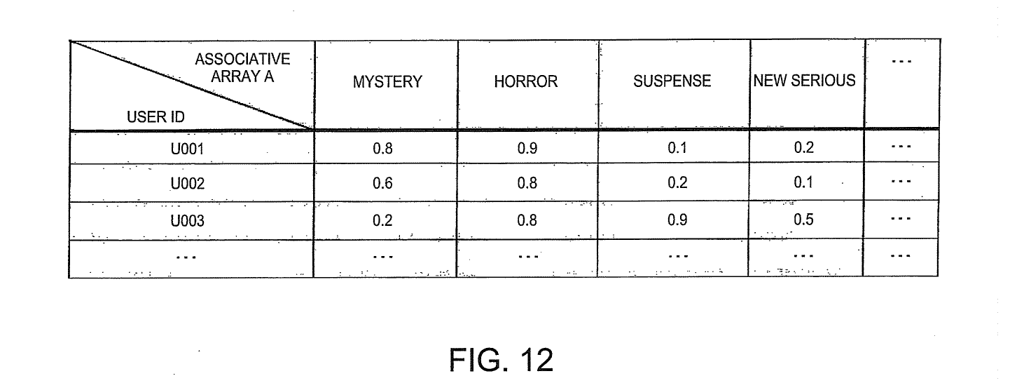

Based on the selection history stored in the selection history storage unit 53, the first estimation unit 14 estimates first preference information of the target user. FIG. 12 is one example of the first preference information.

As the first preference information, an extent of each user's preference for each word of the book attribute (stored in the contents storage unit 51) is digitized by using the selection history (stored in the selection history storage unit 53). Hereinafter, the first preference information is called “book preference value”. In example of FIG. 12, “mystery”, “horror”, “suspense” and “new serious”, are each word included in the book attribute stored in the contents storage unit 51 (array of each word is defined as an associative array A). The book preference value of each user is described in correspondence with each word.

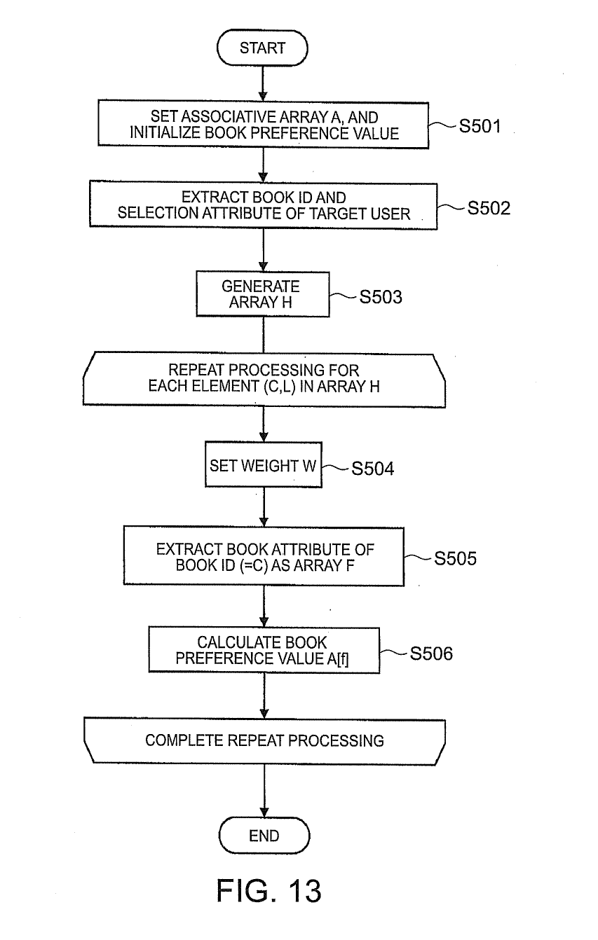

FIG. 13 is a flow chart of processing of the first estimation unit 14. The first estimation unit 14 sets an associative array A having each word included in the book attribute (stored in the contents storage unit 51) as keywords, and initializes the book preference value to an initial value “0” (S501).

The first estimation unit 14 extracts the book ID and the selection attribute corresponding to the user ID of the target user, from the selection history storage unit 53 (S502). The first estimation unit 14 generates an array H (book ID, selection attribute) as a pair of the book ID and the selection attribute (extracted) (S503). Briefly, the array H is generated as the number of pairs of the book ID and the selection attribute. Hereinafter, an element of the book ID is “C”, an element of the selection attribute is “L”, and the array H(C,L) is explained. The first estimation unit 14 repeats processing of S504˜S507 (explained hereinafter) as the number of the array H(C,L).

Based on the selection attribute L, the first estimation unit 14 sets a weight W used for calculation of the book preference value (S504). For example, the first estimation unit 14 sets the weight W to 0.1 if the selection attribute L is “browse”, and sets the weight W to 0.5 if the selection attribute L is “purchase”. A method for setting the weight W may be previously determined.

The first estimation unit 14 extracts the book attribute of a book ID (=C) as an array F from the contents storage unit 51 (S505).

As to each word f of the array F extracted, the first estimation unit 14 calculates a book preference value A[f] by using the weight W and the number of occurrences of the word f (S506). For example, the first estimation unit 14 may calculate the book preference value A[f] by an equation (1).

A[f]=A[f]+W (1)

By repeating this calculation, as to each word included in the book attribute of each book ID in the array H, a sum of weight W is calculated. For example, as a real number vector shown in FIG. 12, the first estimation unit 14 can estimate the first preference information.

Moreover, a method for calculating the book preference value is not limited to the equation (1). Another method such as weighted average or weighted sum may be used. For example, the latest history is reflected in the user's preference at that time. Accordingly, if registration time of the history is newer, the weight W may be larger.

Furthermore, in order to easily separate the preference for book from the preference for catch phrase, the weight W may be changed based on an extent that the user takes an interest in the catch phrase. In this case, for example, a plurality of users having similar preference for catch phrase is extracted. Among the plurality of users, a weight W of a book to which a catch phrase having high click ratio is assigned may be set to smaller value.

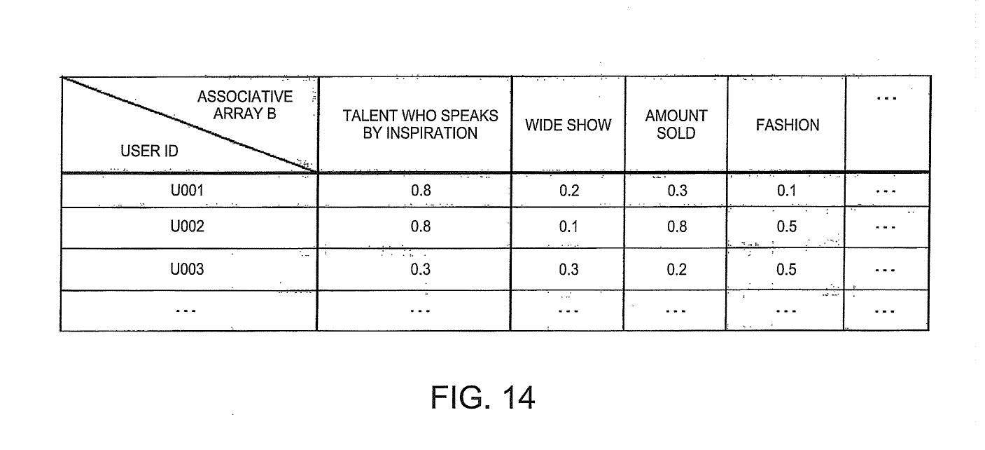

Based on the selection history stored in the selection history storage unit 53, the second estimation unit 15 estimates second preference information of the target user. FIG. 14 is one example of the first preference information.

As the second preference information, an extent of each user's preference for each word of the catch phrase attribute (stored in the catch phrase storage unit 52) is digitized by using the selection history (stored in the selection history storage unit 53). Hereinafter, the second preference information is called “catch phrase preference value”. In example of FIG. 14, “talent who speaks by inspiration”, “wide show”, “amount sold” and “fashion”, are each word included in the catch phrase attribute stored in the catch phrase storage unit 52 (array of each word is defined as an associative array B). The catch phrase preference value of each user is described in correspondence with each word.

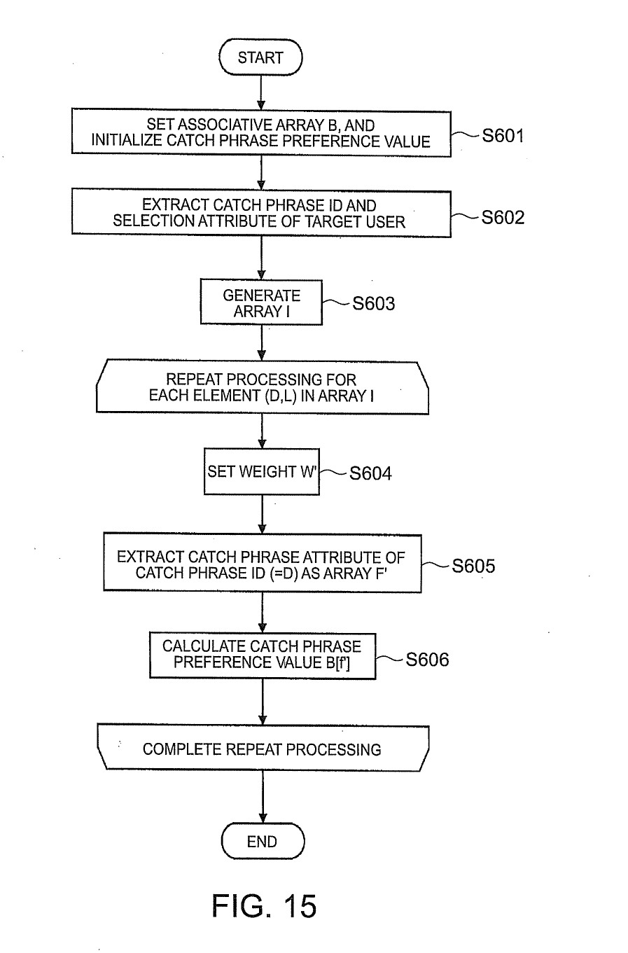

FIG. 15 is a flow chart of processing of the second estimation unit 15. The second estimation unit 15 sets an associative array B having each word included in the catch phrase attribute (stored in the catch phrase storage unit 52) as keywords, and initializes the catch phrase preference value to an initial value “0” (S601).

The second estimation unit 15 extracts the catch phrase ID and the selection attribute corresponding to the user ID of the target user, from the selection history storage unit 53 (S602). The second estimation unit 15 generates an array I (catch phrase ID, selection attribute) as a pair of the catch phrase ID and the selection attribute (extracted) (S603). Briefly, the array I is generated as the number of pairs of the catch phrase ID and the selection attribute. Hereinafter, an element of the catch phrase ID is “D”, an element of the selection attribute is “L”, and the array I (D,L) is explained. The second estimation unit 15 repeats processing of S604˜S607 (explained hereinafter) as the number of the array I (D,L).

Based on the selection attribute L, the second estimation unit 15 sets a weight W′ used for calculation of the catch phrase preference value (S604). For example, the second estimation unit 15 sets the weight W′ to 0.5 if the selection attribute L is “browse”, and sets the weight W′ to 0.1 if the selection attribute L is “purchase”. A method for setting the weight W′ may be previously determined.

The second estimation unit 15 extracts the catch phrase attribute of a book ID (=D) as an array F′ from the additional information storage unit 52 (S605).

As to each word f′ of the array F′ extracted, the second estimation unit 15 calculates a catch phrase preference value B[f′] by using the weight W′ and the number of occurrences of the word f′ (S606). For example, the second estimation unit 15 may calculate the catch phrase preference value B[f′] by an equation (2).

B[f′]=B[f′]+W′ (2)

By repeating this calculation, as to each word included in the catch phrase attribute of each book ID in the array I, a sum of weight W′ is calculated. For example, as a real number vector shown in FIG. 14, the second estimation unit 15 can estimate the second preference information.

Based on the first preference information and the second preference information of a target user, the score calculation unit 16 calculates a recommendation score Z to select books and catch phrases, to be presented to the target user.

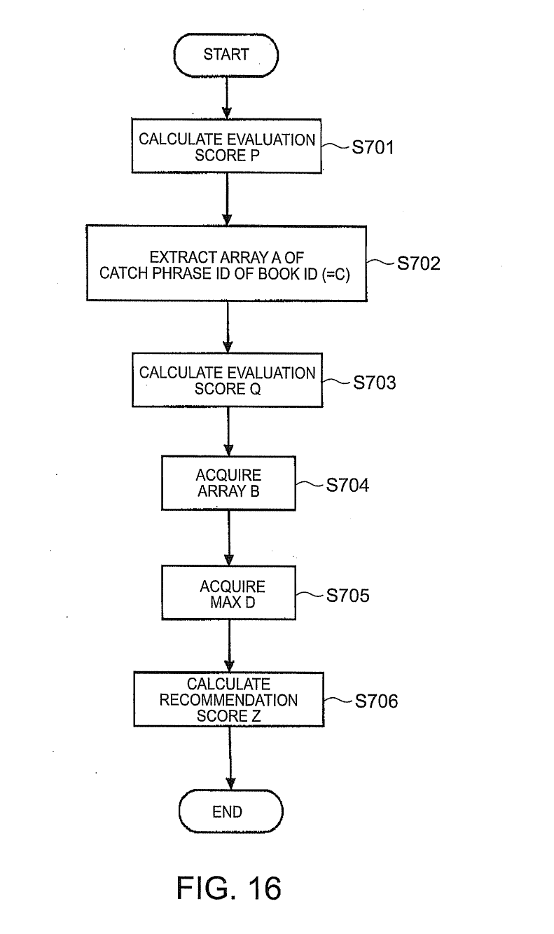

FIG. 16 is a flow chart of processing of the score calculation unit 16. As to a book having the book ID (=C), the score calculation unit 16 calculates an evaluation score P before a catch phrase is assigned thereto (S701). Briefly, as a similarity between a real number vector of book attribute of the book ID (=C) (stored in the contents storage unit 51) and a real number vector of the first preference information (estimated by the first estimation unit 14), the score calculation unit 16 calculates an evaluation score P.

Here, the book attribute is represented by a space of the same real number vector as the real number vector of the first preference information. As to each word as keywords of the associative array A representing the first preference information, the book attribute is “1” if similar word is included therein, and the book attribute is “0” if similar word is not included therein. Moreover, the similarity may be calculated by any method for representing a similarity between two real number vectors, such as a cosine similarity. Furthermore, by reflecting the first preference information of similar users with cooperative filtering method, the evaluation score P may be calculated.

From the additional information storage unit 52, the score calculation unit 16 extracts an array A of all catch phrase IDs assigned to a book having the book ID (=C) (S702).

As to each catch phrase ID (=D) included in the array A, the score calculation unit 16 calculates an evaluation score Q of the catch phrase in the same way as the evaluation score P of the book (S703).

The score calculation unit 16 acquires an array B as a pair (D,Q) (S704). From the array B, the score calculation unit 16 acquires a catch phrase ID having the largest evaluation score MaxQ as MaxD (S705).

The score calculation unit 16 calculates a recommendation score Z of a book (corresponded with a catch phrase) represented as (C, MaxD) by an equation (3) (S706).

Z=α×P+β×Max Q (3)

In the equation (3), coefficient α is a weight coefficient of the evaluation score P of the book, and coefficient β is a weight coefficient of the evaluation score Q of the catch phrase. Two coefficients α and β are initially set to “α=1 and β=1” in order for the user to easily change the setting. In this case, in the information communication terminal 10, a user interface (UI) for the target user to set α and β is displayed. Detail thereof is explained afterwards.

Moreover, an equation to calculate the recommendation score Z is not limited to the equation (3), and may be a non-linear equation. As a result, even if a situation “A user respectively prefers books and catch phrases, but does not prefer combination of books and catch phrases” temporarily occurs, this user's preference is reflected in the recommendation score Z. Furthermore, by assigning a plurality of catch phrases in proportion to a size of a display of the information communication terminal 10, a recommendation score function may be extended as f (P, Q1, Q2, . . . ).

The score calculation unit 16 repeats processing of S701˜S706 to each book.

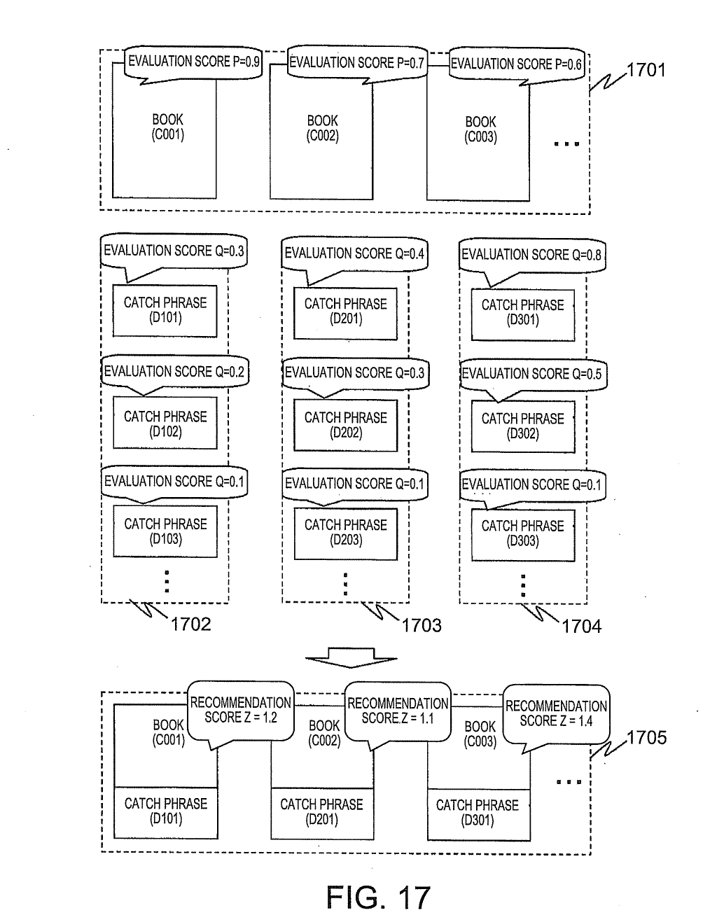

FIG. 17 is a schematic diagram showing one example of calculation method of the recommendation score Z. In a region 1701 of FIG. 17, examples of calculation results of the evaluation score P for each book are shown. In regions 1702, 1703 and 1704 of FIG. 17, examples of catch phrases of each book and calculation results of the evaluation score Q thereof are shown. Concretely, as to a book C001, catch phrases D101, D102, D103 . . . are prepared. The evaluation score P of the book C001 is 0.9, the evaluation score Q of the catch phrase D101 is 0.3, the evaluation score Q of the catch phrase D102 is 0.2, and the evaluation score Q of the catch phrase D103 is 0.1.

In this case, the catch phrase D101 having the largest score is assigned to the book C001, and a total score thereof is 1.2. As to each book stored in the contents storage unit 51, the score calculation unit 16 calculates a recommendation score Z in case of assigning the catch phrase thereto. In a region 1705 of FIG. 17, the recommendation score Z is shown.

In the region 1701, the recommendation score is represented as “(evaluation score P of C001)>(evaluation score P of C002)>(evaluation score P of C003)”. On the other hand, in the region 1705, the recommendation score Z with the catch phrase is represented as “(evaluation score P of C003+evaluation score Q of D301)>(evaluation score P of C001+evaluation score Q of D101)>(evaluation score P of C002+evaluation score Q of D201)”.

For example, when only one book can be displayed because of size of display of the information communication apparatus 10, in conventional technique, the book C001 is displayed. However, in the present embodiment, the book C003 with the catch phrase D301 is displayed. Even if a user does not take an interest in the book C003, by displaying the (attractive) catch phrase D301 therewith, in comparison with displaying the book C001, the user will take more interest in the book C003 than the book C001. As a result, the user can be awakened to new preference.

Based on the recommendation score Z of each book with the catch phrase, the selection unit 17 selects at least one book with the catch phrase to be presented to the target user. In this case, the selection unit 17 may select books with catch phrases in order of higher value of the recommendation score Z, or may select so as not to align books having the same recommendation score Z.

For example, by selecting a wide genre (such as “horror novel”, “manual”, “cartoon” and so on) in which the target user takes an interest, a book with a catch phrase of which the recommendation score Z is high may be selected for each genre. In this case, they may be displayed with comments such as “recommendation of horror novel”, “recommendation of manual”, and “recommendation of cartoon”.

The output unit 18 outputs book information and catch phrases thereof to the information communication terminal 10.

Thus far, the information processing apparatus 1 of the present embodiment is already explained. Hereinafter, the information communication terminal 10 of the present embodiment will be explained.

In the information processing terminal 10, book information and catch phrases (each book with catch phrase thereof) inputted by the information processing apparatus 1 are displayed on a display unit.

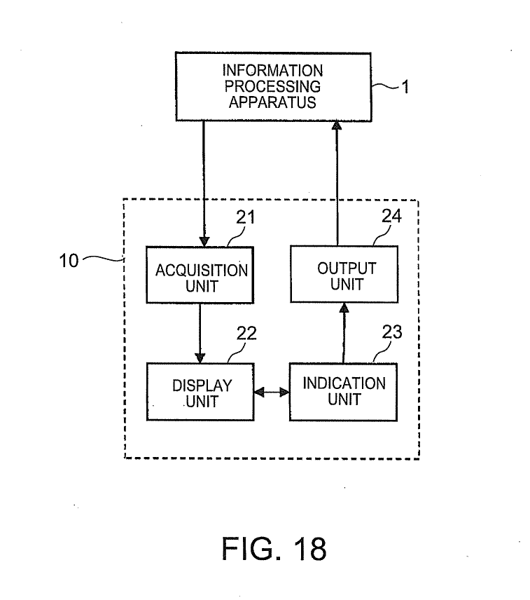

FIG. 18 is a block diagram of the information communication terminal 10 of the present embodiment. As shown in FIG. 18, the information communication terminal 10 includes an acquisition unit 21, a display unit 22, an indication unit 23, and an output unit 24.

The acquisition unit 21 acquires book information and catch phrases (each book with catch phrase thereof) outputted from the information processing apparatus 1.

The display unit 22 displays each book with catch phrase thereof.

By an input from the target user, the indication unit 23 indicates a weight coefficient α of the evaluation score P of the book, and a weight coefficient β of the evaluation score P of the catch phrase.

The output unit 24 outputs the weight coefficient α and the weight coefficient β to the score calculation unit 16 of the information processing apparatus 1. As a result, by using the weight coefficient α and the weight coefficient β, the score calculation unit 16 sets the recommendation score Z.

The acquisition unit 21, the display unit 22, the indication unit 23 and the output unit 24, may be realized by a CPU and a memory used thereby.

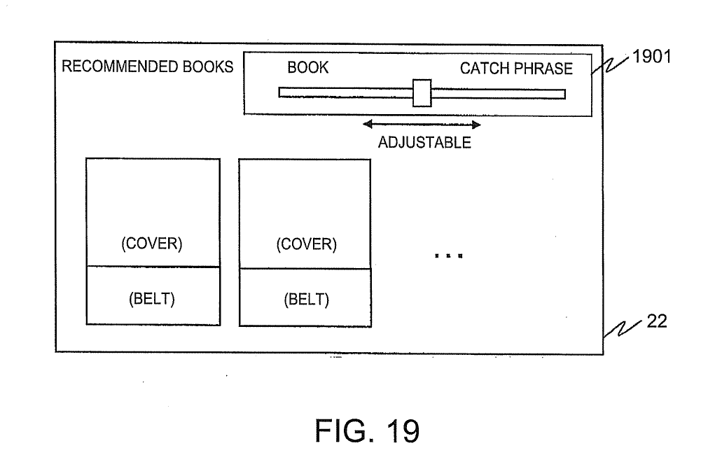

FIG. 19 is one example of book information with catch phrases displayed on the display unit 22, and a UI (user Interface) to indicate the weight coefficient α and the weight coefficient β. For example, the UI may be a slide bar 1901 for a target user to indicate the weight coefficient α and the weight coefficient β.

Based on adjustment of the slide bar 1901 by the target user, the indication unit 23 indicates the weight coefficient α and the weight coefficient β. For example, when the slide bar 1901 is moved to the book side by the target user, the indication unit 23 sets the weight coefficient α to a larger value. When the slide bar 1901 is moved to the catch phrase side by the target user, the indication unit 23 sets the weight coefficient β to a larger value. The output unit 24 outputs the weight coefficient α and the weight coefficient β to the information processing apparatus 1. Moreover, the weight coefficient α and the weight coefficient β may be “0”.

As a result, in the information processing apparatus 1, by using the weight coefficient α and the weight coefficient β, the score calculation unit 16 calculates a recommendation score Z of each book with the catch phrase thereof. Based on the recommendation score Z, the selection unit 17 selects at least one book with the catch phrase thereof. The output unit 18 outputs the selected book and the selected catch phrase as a book with a catch phrase thereof, to the information communication terminal 10.

Then, in the information communication terminal 10, the acquisition unit 21 newly acquires the book with the catch phrase thereof outputted from the information processing apparatus 1. The display unit 22 displays the book with the catch phrase thereof.

As a result, when the target user moves the slide bar 1901 to the book side, the target user can search books matched with the user's preference. When the target user moves the slide bar 1901 to the catch phrase side, from books in which the target user does not take an interest in the past, a book with a catch phrase in which the target user takes an interest can be selected, and presented to the target user.

Moreover, adjustment of the weight coefficient α and the weight coefficient β is not limited to the slide bar 1901. Any UI for the user able to indicate the weight coefficient α and the weight coefficient β may be utilized. Furthermore, the UI to adjust (change) not only the weight coefficient α and the weight coefficient β but also the evaluation score function may be utilized.

According to the present embodiment, contents in which the user actually takes an interest can be estimated.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operating system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for processing information, comprising:
a contents storage unit to store a plurality of contents;
an additional information storage unit to store a plurality of additional information each differently corresponding to each of the contents;
a selection history storage unit to store a history of selection from the contents and the additional information by a user in the past;
a first estimation unit configured to estimate a first preference information representing a tendency of the user's preference for the contents, based on the history;
a second estimation unit configured to estimate a second preference information representing a tendency of the user's preference for the additional information, based on the history; and
a selection unit configured to select a recommended content from the contents, and to select a recommended additional information from the additional information, based on the first preference information and the second preference information.

2. The apparatus according to claim 1, further comprising:
a score calculation unit configured to calculate a recommendation score representing a level of the user's interest for a pair of each content and each additional information, based on the first preference information and the second preference information.

3. The apparatus according to claim 2, wherein
the score calculation unit calculates an evaluation score P representing a level of the user's interest for the contents based on the first preference information, calculates an evaluation score Q representing a level of the user's interest for the additional information based on the second preference information, and calculates the recommendation score based on the evaluation score P and the evaluation score Q.

4. The apparatus according to claim 1, wherein
the content is a book, and
the additional information is a catch phrase corresponding to the book.

5. A method for processing information, comprising:
estimating a first preference information representing a tendency of a user's preference for a plurality of contents, based on a history of selection from the contents and a plurality of additional information by the user in the past, each additional information differently corresponding to each content;
estimating a second preference information representing a tendency of the user's preference for the additional information, based on the history; and
respectively selecting a recommended content from the contents and a recommended additional information from the additional information, based on the first preference information and the second preference information.

6. A non-transitory computer readable medium for causing a computer to perform a method for processing information, the method comprising:
estimating a first preference information representing a tendency of a user's preference for a plurality of contents, based on a history of selection from the contents and a plurality of additional information by the user in the past, each additional information differently corresponding to each content;
estimating a second preference information representing a tendency of the user's preference for the additional information, based on the history; and
respectively selecting a recommended content from the contents and a recommended additional information from the additional information, based on the first preference information and the second preference information.

7. An information communication terminal connectable to an information processing apparatus, the terminal comprising:
an indication unit configured to indicate a weight coefficient α of a first preference information representing a tendency of a user's preference for contents, and a weight coefficient β of a second preference information representing a tendency of the user's preference for additional information corresponding to the contents;
an output unit to output the weight coefficient α and the weight coefficient β to the information processing apparatus;
an acquisition unit configured to acquire a recommended content and a recommended additional information selected based on the first preference information, the second preference information, the weight coefficient α and the weight coefficient β by the information processing apparatus; and
a display unit to display the recommended content and the recommended additional information.

8. The terminal according to claim 7, wherein
the display unit displays an interface to set the weight coefficient α and the weight coefficient β, and
the indication unit indicates the weight coefficient α and the weight coefficient β set by the interface.

9. A method for controlling an information communication terminal connectable to an information processing apparatus, the method comprising:
indicating a weight coefficient α of a first preference information representing a tendency of a user's preference for contents, and a weight coefficient β of a second preference information representing a tendency of the user's preference for additional information corresponding to the contents;
outputting the weight coefficient α and the weight coefficient β to the information processing apparatus;
acquiring a recommended content and a recommended additional information selected based on the first preference information, the second preference information, the weight coefficient α and the weight coefficient β by the information processing apparatus; and
displaying the recommended content and the recommended additional information.

10. A non-transitory computer readable medium for causing a computer to perform a method for controlling an information communication terminal connectable to an information processing apparatus, the method comprising:
indicating a weight coefficient α of a first preference information representing a tendency of a user's preference for contents, and a weight coefficient β of a second preference information representing a tendency of the user's preference for additional information corresponding to the contents;
outputting the weight coefficient α and the weight coefficient β to the information processing apparatus;
acquiring a recommended content and a recommended additional information selected based on the first preference information, the second preference information, the weight coefficient α and the weight coefficient β by the information processing apparatus; and
displaying the recommended content and the recommended additional information.
